(19) United States
(12) Patent Application Publication
(10) Pub. No.: US 2023/0053592 A1
(43) Pub. Date: Feb. 23, 2023

(54) PERFORMANCE PROFILER OF THIRD PARTY AUTOMATIONS

(71) Applicant: T-MOBILE USA, INC., Bellevue, WA (US)

(72) Inventors: Peter Myron, Fall City, WA (US); Michael Mitchell, North Bend, WA (US)

(21) Appl. No.: 17/409,312

(22) Filed: Aug. 23, 2021

(51) Int. Cl. G06F 16/957; G06F 11/34; G06F 11/36

(52) U.S. Cl. CPC G06F 16/9577; G06F 11/3419; G06F 11/3664; G06F 11/3688

(57) ABSTRACT

Systems and methods relating to detection and remediation of underperforming third party processes are disclosed. Such systems and methods include implementing web page performance profiling by loading a target web page in a selected testing environment and acquiring data related to performance metrics of third party processes in the selected testing environment. The techniques may be applied to manage third party embedded processes on a client website and implementing a corrective action to remediate the impacting events before the underperforming third party processes are further accessed, thus improving website performance.

### FIELD OF INVENTION

The present disclosure relates to identifying underperforming processes on a web page and implementing corrective actions to improve website performance.

### BACKGROUND OF INVENTION

Websites often include various components to perform specific functions, either automatically upon loading a web page or upon a triggering event (e.g., a user action). Such functions may include various automations, such as information access, updating, and presentation. The performance of website components directly affects the success or failure in meeting its objectives. These components, if not configured or deployed properly, can degrade website performance, which can impact customer satisfaction and retention, affect client productivity, and ultimately reflect on company revenue. Website performance monitoring is the process of testing and verifying that users can reach the content and interact with the content as expected. Such monitoring may involve profiling load time, response time, availability, and reliability of components under different conditions.

Website components may include first party components performing functions associated with the website hosting server itself or with another server operated by the website host or owner. Existing methods of website performance monitoring enable various means of performance monitoring and evaluation for such first party components. However, website components may also include third party components interacting with third party servers to provide additional functionality relating to such third parties. While these third party components often provide an improved user experience on the website through integration of external data and features, they are not typically developed for a specific website. Thus, third party components may cause performance degradation in some circumstances. Existing methods of website performance monitoring and evaluation fail to adequately address such performance issues with third party components, at least in part because portions of the third party components are implemented by remote servers associated with third parties. Thus, methods of third party component performance monitoring and evaluation are needed.

### SUMMARY OF THE INVENTION

The described methods and systems enable detection of underperforming third party processes on a web page by profiling web page performance, and implement a corrective action associated with the underperforming third party processes. The disclosed methods may implement web page performance profiling by loading a target web page in a selected testing environment and acquiring data related to performance metrics of third party processes in the selected testing environment. The disclosed methods may implement a corrective action when a web page user performs a trigger event associated with underperforming third party processes to remediate the impacting events before the user accesses these underperforming third party processes.

In an embodiment, a method for profiling web page performance is implemented. The method may include one or more of: selecting a target web page including a plurality of embedded processes; selecting a testing environment for evaluation of performance of the target web page; loading the target web page in the testing environment; acquiring data related to performance metrics of third party processes of the target web page; determining a group of underperforming third party processes with performance metrics below one or more respective thresholds; and implementing a corrective action associated with the group of underperforming third party processes.

In an embodiment, a computing system for profiling web page performance may include one or more processors and one or more non-transitory memories storing computer-executable instructions communicatively coupled to one or more processors. The computing system may be configured to: select a target web page including a plurality of embedded processes; select a testing environment for evaluation of performance of the target web page; load the target web page in the testing environment; acquire data related to performance metrics of third party processes of the target web page; determine a group of underperforming third party processes with performance metrics below one or more respective thresholds; and implement a corrective action associated with the group of underperforming third party processes.

This summary has been provided to introduce a selection of concepts further described below in the detailed description. As explained in the detailed description, certain embodiments may include features and advantages not described in this summary, and certain embodiments may omit one or more features or advantages described in this summary.

### BRIEF DESCRIPTION OF THE DRAWINGS

The figures described below depict various aspects of the systems and methods disclosed herein. Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive. Further, wherever possible, the following description refers to the reference numerals included in the following figures, in which features depicted in multiple figures are designated with consistent reference numerals.

FIG. 1 illustrates a block diagram of an example performance profiling system in which the techniques of this disclosure for profiling performance of third party processes can be implemented.

FIG. 2 is a flow diagram of an example performance profiling method for profiling performance of third party processes, which may be implemented in the system of FIG. 1.

FIG. 3 is a flow diagram of an example evaluation method for calculating a performance metric for profiling performance of third party processes, which may be implemented in the system of FIG. 1.

FIG. 4 is a flow diagram of an example performance remediation method for predicting user access of underperforming third party processes and causing a corrective action to be implemented, which may be implemented in the system of FIG. 1.

### DETAILED DESCRIPTION OF THE INVENTION

The disclosed systems and methods generally relate to profiling performance of embedded automated processes or components on a website (including third party components), identifying underperforming automated components, and implementing remediation with the purpose of improving overall website performance. In this disclosure, the terms “automated components” and “automations” may be used interchangeably to refer to embedded processes or components of a website, which may include third party processes or components as well as internally developed and hosted processes. For the purposes of this disclosure, the third party embedded automated components are any pieces of software developed and/or distributed and hosted by another entity.

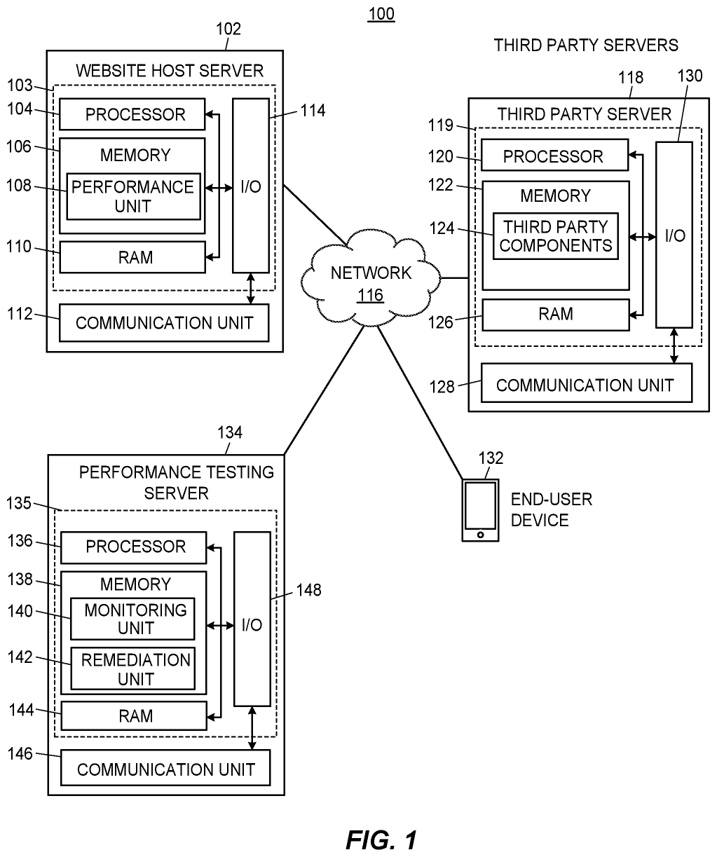

FIG. 1 is a simplified block diagram of an example performance profiling system 100 for identifying underperforming third party processes on a website and implementing corrective actions to improve website performance. The system includes a website host server 102 communicatively coupled to a third party server 118 hosting third party processes, performance testing server 134, and an end-user device 132 via a network 116. Although only one of each of the third party server 118, website host server 102, performance testing server 134, end-user device 132, and network 116 (along with each of their constituent components) is illustrated for simplicity; alternative embodiments may include multiple such components. Additional, fewer, or alternative components or configurations may be implemented in various embodiments.

The network 116 may be a single communication and/or data network, or may include multiple communication and/or data networks (e.g., one or more wired and/or wireless local area networks (LANs), one or more wired and/or wireless wide area networks (WANs), which may include the Internet), one or more public and/or private networks, and/or one or more other types of networks.

The website host server 102 is a computing device hosting a website identified for performance profiling. The website host server 102 includes a controller 103 to receive, store, process, generate, access, and output data. The controller 103 may include a processor 104 and a tangible, non-transitory memory, memory storage device, or data storage unit 106. Processor 104 may be a programmable microprocessor that executes computer-executable instructions stored in the memory 106 to execute some or all of the functions of the website host server 102. The processor 104 may include one or more central processing units (CPUs) and/or one or more graphics processing units (GPUs), for example. Alternatively, or in addition, the processor 104 may be other type of processor (e.g., application-specific integrated circuits (ASICs), field-programmable gate arrays (FPGAs), etc.). Additionally, the controller 103 can include a random access memory (RAM) 110 for temporary memory and an Input / Output (I/O) circuit 114. The components of the controller 103 may be interconnected via an address/data bus or other means.

It should be appreciated that, although only one processor 104 is depicted, in some embodiments the website host server 102 may include multiple processors 104. Similarly, the website host server 102 may include multiple memories 106 or multiple RAMs 110. Although the I/O circuit 114 is likewise depicted as a single block, the I/O circuit 114 may include a number of different I/O circuits 114, which may be configured for specific I/O operations. In embodiments, the RAM 110 and memory 106 may be semiconductor memories, magnetically readable memories, optically readable memories, or any other type of memory.

The website host server 102 includes a communication unit 112 capable of sending and receiving data via wired or wireless communication links to the network 116 to provide network connectivity over the network 116. The communication unit 112 may include hardware and software components (e.g., encoding modules, decoding modules, and antennas) to transmit messages based upon data received from the controller 103 or to provide received messages to the controller 103. The communication unit 112 may transmit and receive wired or wireless communications with external devices via the network 116, using any suitable wireless communication protocol network, such as a wireless telephony network (e.g., GSM, CDMA, LTE, 5G, etc.), a Wi-Fi network (802.11 standards), a WiMAX network, etc. Furthermore, the communication unit 112 may provide input signals to the controller 103 via the I/O circuit 114. The controller 103 of the website host server 102 may further be configured to communicate data through the communication unit 112 using any suitable data protocol.

To implement functionality of the performance profiling system 100, the memory 106 of the website host server 102 may store various applications, routines, software modules, and data. The memory 106 includes a performance unit application 108 (e.g., a web browser or special-purpose application) enabling the profiling of website performance, identifying under-performing third party components, and implementing remediation.

The third party server 118 may comprise one or more servers of third party providers, hosting automations that perform certain actions, tasks, and processes. These automations may include components such as server-side libraries, client-side libraries, frameworks, REST services, widgets, etc., used in client web applications. These automations may be implemented on website(s) hosted by the website host server 102, as well as other websites hosted by other servers (not shown). A third party server 118 may host one or multiple automations implemented on the profiled website hosted by the website host server 102. The third party server 118 comprises a computing device configured to communicate via the network 116, as well as to receive, store, process, generate, access, and output data. Like the website host server 102, the third party server 118 includes a controller 119 that stores and processes electronic data and a communication unit 128 that communicates with external computing devices (e.g., website host server 102, performance testing server 134, or end-user device 132) via the network 116. Similar to controller 103, the controller 119 receives, processes, produces, transmits, and stores data. The controller 119 includes a processor 120, a memory 122, a RAM 126, and an I/O circuit 130, each configured and operating analogously to the corresponding components of the controller 103 described above. The third party server 118 also includes a communication unit 128 configured to send and receive communications between the third party server 118 and external computing devices via a data network connection with the network 116. Similar to the communication unit 112, the communication unit 128 may include software and hardware components configured to enable communication using standard or specialized communication protocols, via wired or wireless communication connections.

To implement the functionality of the performance profiling system 100, the memory 122 of the third party server 118 may store third party components 124, such as applications, routines, software modules, and data. The third party components 124 may execute instructions for third party processes embedded in websites hosted by the website host server 102.

The performance testing server 134 comprises computing components configured to coordinate evaluation of performance of third party automations on a website, and further determine and implement a corrective action associated with the group of underperforming third party automations. The performance testing server 134 may comprise one or more servers configured to communicate via the network 116, as well as to receive, store, process, generate, access, and output data.

Like the website host server 102, the performance testing server 134 includes a controller 135 that stores and processes electronic data and a communication unit 146 that communicates with external computing devices (e.g., website host server 102, third party server 118, or end-user device 132) via the network 116. The controller 135 may convey, for example, data, updates, alerts, notifications, status updates, etc. related to the performance testing data and performance testing results to the website host server 102 and the third party server 118. Similar to controller 103, the controller 135 receives, processes, produces, transmits, and stores data. The controller 135 includes a processor 136, a memory 138, a RAM 144, and an I/O circuit 148, each configured and operating analogously to the corresponding components of the controller 103 described above. The performance testing server 134 also includes a communication unit 146 configured to send and receive communications between the performance testing server 134 and external computing devices via a data network connection with the network 116. Similar to the communication unit 112, the communication unit 146 may include software and hardware components configured to enable communication using standard or specialized communication protocols, via wired or wireless communication connections.

To implement functionality of the performance profiling system 100, the memory 138 of the performance testing server 134 may store various applications, routines, software modules, and data. The memory 138 includes a monitoring unit 140 for monitoring performance of automated components of websites and a remediation unit 142 for implementing remediation of automated components determined to have detrimental impacts on website performance, as described elsewhere herein.

The end-user device 132 is a computing device associated with a client, customer, or a website user, via which the end-user interacts with a website hosted by a website host server 102 via the network 116. The end-user device 132 may be a smartphone, a workstation computer, a tablet computer, a smart device (e.g., a smart speaker, a personal digital assistant device, or an Internet-of-Things (loT) connected device or component), or any other type of computing device capable of receiving and processing electronic information through an electronic communication network including emulated synthetic versions of the aforementioned. The end-user device 132 may send or receive instructions, queries, requests, or perform any other suitable transactions via the network 116 to/from the website host server 102.

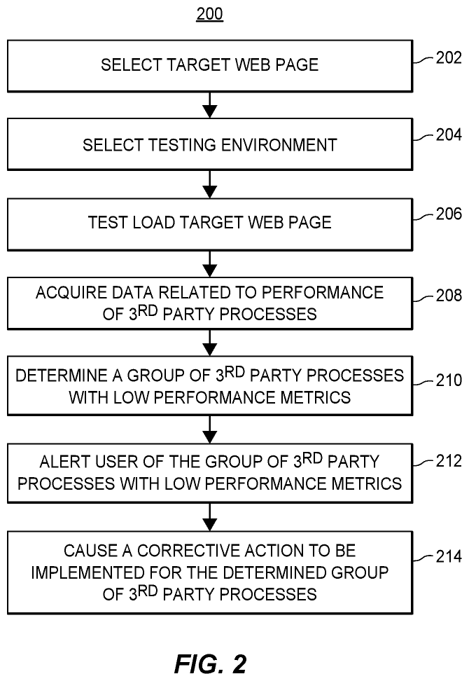

FIG. 2 illustrates a flow diagram of an example performance profiling method 200 for profiling performance of third party processes embedded or called from a website or web application and determining a corrective action for processes with low performance metrics. The performance profiling method 200 describes synthetic monitoring (also known as active or directed monitoring), which uses a script to generate a monitored activity, mimicking a user transaction. Scripts synthetically generate traffic to monitor how a website performs for end-users. Synthetic monitoring as a diagnostic method offers a flexibility to monitor performance at desired frequencies, curated geographic locations, and with diverse parameters (such as browser types or connection speeds). Such monitoring provides a fast way to identify website performance issues before they cause user impact and generates necessary data to formulate performance remediation actions.

The performance profiling method 200 utilizes synthetic monitoring to determine performance metrics of third party processes. The performance metrics may be used to identify low performing or underperforming third party processes, for example processes with load time exceeding a certain threshold under select browser and/or network connection speed conditions. The third party performance metrics may be used to determine when to alert, for example, a website host or a provider of the third party process(es) of performance issues. The third party performance metrics may further be used to determine when to generate and cause a corrective action, such as proactively loading an automation, displaying an automation only when actually accessed, or disabling an automation, and thus may prevent or decrease web page content access delays. Timely detection and remediation of web page access issues such as bottlenecks and non-performant content can prevent user impact events. The performance metrics may also be used to adjust Service Level Agreements (SLAs) in situations where service guarantees do not match certain aspects of service execution.

In some embodiments, at least a portion of the method 200 is performed by one or more processors of the performance profiling system 100 of FIG. 1. For example, at least portions of the method 200 may be performed by the processor 136 of the performance testing server 134 (e.g., by utilizing the monitoring unit 140 and the remediation unit 142), the processor 104 of the website host server 102 (e.g., by utilizing the performance unit 108), and/or the processor 120 of the third party server 118 (e.g., by utilizing the third party components unit 124). In embodiments, the method 200 may include additional or alternate aspects not shown in FIG. 2.

At block 202, the one or more processors select a target web page for performance profiling, using one or more selection criteria. The target web page may be selected from available pages of a target website hosted on a website host server 102. The selection criteria may include selecting a main or a landing page of the target website, and following each branch of a site tree or a site map in chronological order to choose each subsequent target web page, until every page on the site map has been profiled for performance. The selection criteria for choosing a web page for performance profiling after the main page may include simulating an end-user's clickstream through basic navigation, form submission, or shopping-cart transactions. Alternatively, the selection criteria may include analyzing average load times for each web page of the target website (e.g., in the last day, week, or month), and prioritizing profiling web pages with slower loading times, arranging the order of profiling from slowest to fastest web pages. In an alternative embodiment, the selection criteria may be based on web page usage statistics, for example prioritizing profiling web pages with most loads or with highest visit count (e.g., in the last day, week, or month, etc.).

In some embodiments, selecting a target web page for performance profiling may also include choosing how often to initiate performance testing. In some such embodiments, a target web page may be selected for testing at regularly occurring set intervals (e.g., every 1, 5 or 15 minutes). In alternative embodiments, the one or more processors may continuously select a target web page after completing a profiling process of the performance profiling method 200, initiating the selection of the target web page after completing a previous implementation of the method 200. Alternatively, the one or more processors may initiate the selecting of multiple target web pages concurrently, such that multiple pages are being evaluated at the same time.

At block 204, the one or more processors may select or determine a testing environment. The testing environment is the emulated environment of a hypothetical end-user device accessing the target web page. Selecting the testing environment may include selecting a device type via which the hypothetical end-user interacts with a website hosted on a website host server 102. The type of the end-user device 132 may be a smartphone, a workstation computer, a laptop, a tablet computer, a smart device (e.g., a smart speaker, a personal digital assistant device, or an Internet-of-Things (loT) connected device or component), or any other suitable type of computing device.

Selecting the testing environment at block 204 may include, for example, selecting an Operating System (OS) of the end-user device (e.g., Microsoft Windows, Apple macOS, Apple's iOS, Android, Linux, or a specialized OS, such as an embedded or a real-time system). Selecting the testing environment at block 204 may also include, for example, selecting a web browser type (e.g., Google Chrome, Safari, Firefox, Opera, Internet Explorer, or Tor). Selecting the testing environment may further include selecting an internet connection type or speed, or a download speed (e.g., 8, 12, 25, 100, or 200 Mbps), a level of network congestion or other parameters, and/or selecting a geographical location of the emulated end-user (e.g., a country, a state, or a city).

At block 206, the one or more processors may perform a loading of the target web page in a testing environment, also referred to here as “test loading.” The test loading may include sending a request via the network 116 to the website host server 102, where the processor 104 processes the request and sends a response via the network 116 back to the one or more processors. The one or more processors receive the response and start to process the Document Object Model (DOM) of the web page. After the one or more processors complete loading the DOM, the browser uses the loaded DOM to start rendering the web page. A window load event signals a finished web page loading process.

In some embodiments, the test loading of the target web page includes monitoring, or quantifying the client-side and the server-side processes and operations during test loading of the target web page. The one or more processors may register time (e.g., measured in milliseconds) spent on the processes, including at least one of the following: time spent on server side access, which is the time spent on the application or website host server 102 or time spent on third party server(s) 118 (e.g., time spent processing the request from the one or more processors for web page or automation loading), network call times (e.g., time spent in redirects, requesting, and receiving HTML or XML, or request que time), DOM processing times (e.g., loads, accesses, and invocations), or library access times (e.g., loads, accesses, and invocations). In certain embodiments, the one or more processors may quantify the client-side and the server-side interactions only for the third party embedded processes.

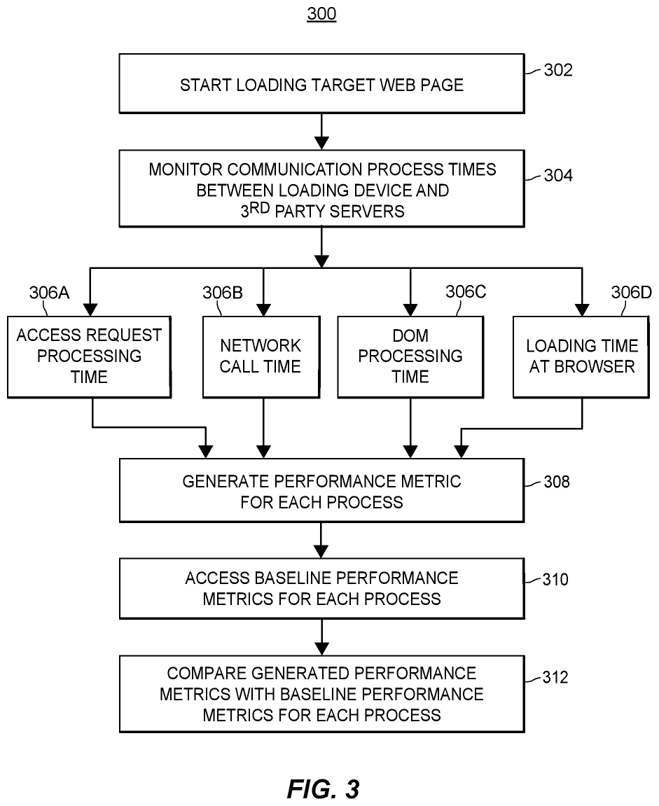

At block 208, the one or more processors acquire data related to performance of third party processes hosted by the third party servers 118. Performance data on third party processes is selected from the monitoring data registered at the block 206. The one or more processors may determine which monitoring data corresponds to the data profiling the respective third party processes by comparing the monitoring data identifiers to a list of third party processes' identifiers, provided, for example, by the processor 104. Alternatively, the one or more processors may employ an algorithm, for example a machine learning algorithm, to identify which monitoring data corresponds to the data monitoring the performance of third party processes. The performance metrics of third party processes may include third party server 118 access time, automation request que time, automation request receiving and/or redirecting time, and automation load time, etc. Monitoring and performance metric calculation is further described in more detail with reference to FIG. 3.

At block 210, the one or more processors determine a group of underperforming third party processes, or third party processes with low performance metrics. In embodiments, the acquired data on the performance of third party processes is analyzed to generate performance metrics for each of the third party processes and to identify which of the third party processes' performance metrics fall below one or more thresholds of minimum acceptable performance values. The analysis and grouping may be based on the different conditions of the testing environment selected at the block 204. The thresholds may be determined by the SLA or any other performance agreement between the website host and the third party provider(s), or the thresholds may be determined by the website client based on metrics determined by client practices. The thresholds may be, for example, measurements of duration of time (e.g., measured in milliseconds) it takes to complete each of the steps involved in loading a third party process on an end-user's device. Other criteria may be used to identify third party processes with low performance metrics. In embodiments, historical performance data may be monitored to identify patterns of low performance metrics (e.g., as a function of different testing conditions) or changes in performance metrics over time (e.g., improving or deteriorating performance metrics). The one or more processors may identify bottlenecks or common low-performance practices, which may include identifying third party processes that fail to perform properly (e.g., by failing to load). In embodiments, the determination may include a ranking of the third party processes according to their performance metrics, where the underperforming third party processes are ranked, for example, from highest to lowest performance metrics.

At block 212, the one or more processors alert a user or users of performance issues with the group of third party processes with low performance metrics. For example, the one or more processors may send an alert, notification, or a status update to an external computing device (e.g., the website host server 102, the third party server 118, a computing device(s) coupled to the website host server 102 or the third party server 118, computing devices associated with application and/or third party processes support groups, etc.). In embodiments, the one or more processors may send the alert, notification or a status update to each of the third party servers 118 hosting the underperforming third party processes, communicating only the performance data for their respective processes. The alert, notification, or the status update may communicate which of the third party processes were identified to have low performance metrics, as well as conditions or environmental parameters associated with low performance in some embodiments. The one or more processors may communicate the performance metrics of the group of underperforming processes detected at the block 206 under the conditions of the testing environment selected at the block 204, along with the conditions of the testing environment selected at the block 204. The one or more processors may also include data on negative user impact (such as estimated load delay, restricted access, or delayed or restricted invocation) of the group of the underperforming third party processes. The alert may be, for example, a graphical user notification, an email message, a text message, or a phone call. The alert may contain text and/or visual or graphic information. The alerts, notifications, or status updates may be stored in a cache, datastore, memory, etc. (e.g., memory 106 or 122) for subsequent recall.

The alert may be sent immediately following each determination of the respective processes with low performance metrics or at scheduled time intervals (e.g., every 30, 60 minutes, or every 24 hours). In embodiments, there may be different alerting protocols for different performance metrics, and/or different alerting protocols for different third party providers, and/or for different third party processes. For example, the one or more processors may determine, from the group of third party processes with low performance metrics, a group of third party processes with critically low performance metrics and push an alert on these processes to the user outside of the regularly scheduled communication (e.g., immediately following the determination). The alert may include a summary report on the performance of the respective third party processes and/or a record of change over a time (e.g., an hour, 24 hours, a week, or a quarter) and/or a record of change over a range of conditions (such as the conditions of the testing environment selected at the block 204).

At block 214, the one or more processors cause a corrective action to be implemented for the determined group of third party processes with low performance metrics. Causing the corrective action to be implemented may include communicating with one or more of the website host server 102 or the third party servers 118 to cause such servers to implement changes relating to the determined third party processes. The corrective action may include client side recommendations or server side recommendations. The client side recommendations may include, for example, preloading or delayed loading of the third party processes or a group of third party processes with low performance metrics, batching of network calls, displaying automation only when actually accessed, partially loading an automation, loading a different version of an automation, or loading a different automation, etc. The server side recommendations may include, for example, moving the affected embedded processes to Model-View-View-Model (MVVM) or to microservices, or the recommendations may include architectural reorganizations, etc.

In some embodiments, the corrective action may include enforcement mechanisms for a Service Level Agreement (SLA) with the provider of the underperforming process(es). For example, the corrective action may include processes for dynamic updating of the SLA depending on the performance metrics of the third party processes. The SLA may include a multi-level pricing model, where one or more processors dynamically adjust the pricing model to the appropriate pricing level depending on an analysis of performance metrics of the processes covered by the SLA. The adjustment may be based on the results of the analysis of performance metrics for an individual embedded process, or for a group of embedded processes over a certain time period and a determination of whether, for example, a mean performance metric is at, above, or below an agreed performance value or a threshold (e.g., evaluation of load time under certain testing environment conditions). A corrective action may include generating additional computing resources to serve client's demands, for example, adding hardware or software components in a cloud computing environment using predefined or known configuration parameters.

FIG. 3 illustrates an example evaluation method 300 that may be used to implement blocks 206 - 210 of the performance profiling method 200 by calculating a score or a metric for profiling the performance of third party processes and determining whether and how that score or metric deviates from the baseline performance for each monitored process. In an embodiment, at least a portion of the method 300 is performed by one or more processors of the performance profiling system 100 of FIG. 1. For example, at least portions of the method 300 may be performed by the processor 136 of the performance testing server 134 (e.g., by utilizing the monitoring unit 140 and the remediation unit 142) and/or by the processor 104 of the website host server 102 (e.g., by utilizing the performance unit 108). In embodiments, the method 300 may include additional or alternate aspects not shown in FIG. 3.

At block 302, the one or more processors start loading a target web page. The target web page may be a page selected at block 202 of the performance profiling method 200. The loading of the target web page may be similar to the loading process described in the block 206 of the method 200. Loading the target web page includes loading the third party embedded processes hosted on the third party servers 118. In some embodiments, the performance testing server 134 causes the one or more processors to load the target web page within a testing environment to evaluate performance under testing parameters associated with the testing environment. In some such embodiments, one or more testing parameters defining the testing environment may be selected or generated by the performance testing server 134, some or all of which may be communicated to the web host server 102 in a request for the target web page.

At block 304, the one or more processors monitor communication process times of communication processes via the network 116 between a loading device (e.g., the performance testing server 134) and the one or more third party servers 118. The communication process times are the times observed for communication processes to complete, which may in some embodiments be divided into various categories such as those discussed below. Monitoring the processes may include quantifying the processes, such as recording the time each process takes from start to finish. Monitoring the processes may also include recording the time associated with each of a plurality of stages of the process.

Blocks 306A-306D include examples of categories of communication processes monitored at the block 304, such as access request processing time (306A), network call time (306B), DOM processing time (306C), and loading time at browser (306D). The example processes are not limited to the examples depicted by the blocks 306A - 306D, as there may be additional communication processes between the loading device and the third party servers that are monitored and quantified. The monitoring of the communication processes may be quantifying the time (e.g., measured in milliseconds) it takes for each process from start to finish. The access request processing time may include quantifying the time it takes for a request to access a third party automation process, for example, from a performance testing server 134 or a website host server 102, to be processed by a third party server 118. The network call time may include quantifying the time spent on communication functions of the network 116 in requesting, redirecting, and receiving HTML or XML code for the third party processes, as well as the time spent in a request queue of network calls. The DOM processing time may include quantifying the time spent on loads, accesses, and invocations of the third party processes on the device or the performance testing server. The loading time at browser may include quantifying the time it takes for a browser to render the third party processes on the device or the performance testing server.

At block 308, the one or more processors generate a performance metric for each third party process. The performance data on the communication processes of the third party processes of blocks 306A-306D is processed to generate a performance metric for each monitored third party process. The performance metrics may be generated from the loading time for each process, or a combination of the loading time and the specific testing environment characteristics selected at the block 204. For example, the third party processes performance metrics may be the loading time (in milliseconds) multiplied by coefficients corresponding to user device type, OS type, web browser type, internet connection speed, and a geographical location. Alternatively, the third party processes performance metrics may be derived as a relationship between the processes loading time, the testing environment characteristics, and the loading times defined by the SLA or any other performance agreement between the website host and the third party providers. Other criteria may be used to generate the performance metric for each third party process. Such performance metrics may be stored in the memory 138 of the performance testing server 134 or in another memory, such as a network-connected database.

At block 310, the one or more processors access baseline performance metrics for each third party process. The baseline performance metrics may be retrieved from memory storage of the third party servers 118, the performance testing server 134, or the website host server 102. The baseline performance metrics may be, for example, baseline performance data defined by the SLA or performance criteria set by the performance testing server 134. The baseline performance metrics may be, for example, values of maximum acceptable durations of time (e.g., measured in milliseconds) to complete each communication process involved in loading a third party automation on an end-user's device for respective testing environment characteristics. The performance criteria may be pre-determined or dynamic. Dynamic criteria for the baseline performance metrics may be determined using an algorithm that accounts for the testing environment conditions. In some embodiments, dynamic baseline performance criteria may be generated based upon past performance of a third party process, thus facilitating rapid and automated identification of process changes that are detrimental to performance (e.g., process updates or third party server issues). For example, third party process performance may be evaluated on a periodic basis to establish baseline performance against which to evaluate future performance. Other criteria or parameters may be used to define the baseline performance metrics for the third party processes.

At block 312, the one or more processors compare calculated performance metrics with baseline performance metrics for each third party process. Comparing the performance metrics may include calculating a difference between the generated performance metrics and the baseline performance metrics, which may be further evaluated to determine whether the variation is within acceptable limits that are either fixed or relative to other third party process performance. Alternatively, such comparison may include determining if the generated third party processes performance metrics are above or below the threshold of their respective baseline performance metrics. Other criteria may be used to compare the metrics. The evaluation method 300 then ends, and the results may be used to identify low-performing third party process and take remedial actions, as discussed elsewhere herein.

Synthetic monitoring tests are generated through controlled and predictable environments, where the scripts execute a known set of steps at regular intervals under controlled conditions. User telemetry data (real user monitoring data), on the other hand, can offer real user browsing trends and statistics over time. Using the data from both real user monitoring and synthetic monitoring provides the ability to analyze specific issues and resolve shortcomings, expanding monitoring visibility. Real user telemetry data can help identify triggers that signal anticipated loads, accesses, and invocations of the third party embedded processes. Combining synthetic monitoring performance testing with real user telemetry data can help identify browsing session events that precede accessing of the underperforming third party embedded processes by real users, thus allowing the system to initiate a timely corrective action before a user selects a link to a web page that contains underperforming third party processes. This method offers an advantage of both identifying issues with third party processes, and resolving them before they negatively affect the user's website experience or manifest user impact events. It should be noted that a single user's impacted experience could affect other users' experiences. For example, a lag in one or many users' experiences caused by a third party process may trip a circuit breaker for all subsequent users until a corrective action is applied.

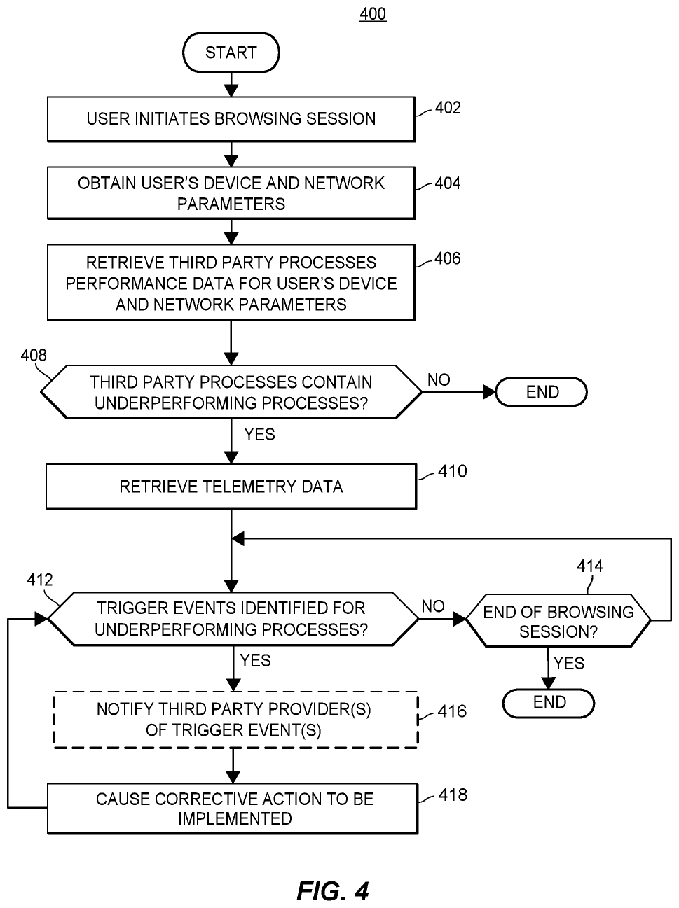

FIG. 4 illustrates a flow diagram of an example performance remediation method 400 for identifying trigger events to accessing underperforming third party processes in real user's browsing session and causing a corrective action to be implemented to remediate the impacting events before the user accesses the underperforming third party processes. The performance remediation method 400 describes a method that utilizes performance data on third party processes obtained using synthetic monitoring of the performance profiling method 200 in combination with telemetry data on user browsing trends and statistics on trigger events for underperforming processes. If the method 400 identifies the occurrence of a trigger event for one or more underperforming processes, it initiates a process of causing a corrective action to be implemented to avoid or reduce the performance impact. The corrective action may be specific for the user's device and network parameters or characteristics. In some embodiments, such process may require the user to opt in or perform an explicit action to enable sharing browsing trends and statistics data.

In an embodiment, at least a portion of the method 400 is performed by one or more processors of the performance profiling system 100 of FIG. 1. For example, at least portions of the method 400 may be performed by the processor 136 of the performance testing server 134 (e.g., by utilizing the monitoring unit 140 and the remediation unit 142), the processor 104 of the website host server 102 (e.g., by utilizing the performance unit 108), and/or the processor 120 of the third party server 118 (e.g., by utilizing the third party components unit 124). The client website may be accessed by a user device similar to the end-user device 132. In embodiments, the method 400 may include additional or alternate aspects not shown in FIG. 4.

At block 402 the user initiates a browsing session on a client website. The browsing session may be initiated on any personal computing device (such as the end-user device 132) equipped to access a website or a web application via a network, such as the network 116. The user may initiate the browsing session by initiating interaction with a website, which may include entering an address of a web page on the website, or clicking on a link that directs the user to the web page. For example, a single session may contain multiple web page views, social media interactions, interactions with advertisements, ecommerce transactions, etc. A user may initiate multiple browsing sessions in one day, where each can be, for example, terminated by the user or timed out by the website host server due to user inactivity.

At block 404 the one or more processors obtain the user's device and network parameters. The user's network parameters may include parameters such as download speed, upload speed, and latency. The download and upload speed may be measured in megabits per second (Mbps), and latency may be measured in milliseconds. The user's device type and OS may be obtained, as well as the user's geographic location. The obtained parameters may be stored in cache, datastore, memory, etc. (e.g., memory 106 or 138) for subsequent recall.

At block 406 the one or more processors retrieve third party processes performance data for the user's device and network parameters obtained at the block 404. For example, the third party processes performance data may be the data on the third party processes acquired at block 208 of the performance profiling method 200, filtered for the specific user device and network parameters obtained at the block 404. Alternatively, the third party processes performance data may be the data on the third party processes with low performance metrics determined at block 208 of the performance profiling method 200. The third party processes performance data may be retrieved from data stored on cache, datastore, memory, etc. (e.g., memory 138, 102, or 122). Other sources may be used for retrieval of the third party processes performance data for the user's device and network parameters.

At block 408 the one or more processors determine whether the third party processes retrieved at the block 406 contain underperforming processes. If the dataset retrieved at the block 406 does not contain underperforming third party processes, the method 400 terminates. If the dataset retrieved at the block 406 contains underperforming third party processes, the method 400 advances to block 410.

At block 410 the one or more processors retrieve telemetry data. The telemetry data may be retrieved, for example, from memory 138, memory 106, memory 122, or a database (not shown) communicatively coupled to the one or more processors. In embodiments, the telemetry data may be data collected by the monitoring unit 140, the performance unit 108, or data obtained from an external database (not shown). The telemetry data may be data acquired from real users' browsing history on the same website where the browsing session was initiated at the block 402. In embodiments, the telemetry data may be acquired from browsing history on different websites that contain the same or similar third party processes, or any other suitable sources.

The telemetry data may include data on real users' browsing history sequences leading up to accesses, loads, or invocations of third party processes. The telemetry data may also include triggers or trigger events identified from the real users' browsing history that are associated with accesses, loads, or invocations of each of the third party processes. The trigger event may be, for example, a web page access, a social media interaction, an interaction with advertisements, ecommerce transactions, an interaction with website support, etc. In embodiments, the telemetry data may contain trigger events and their weights or coefficients corresponding to the probability of each trigger event leading to access of a respective third party process.

At block 412 the one or more processors determine whether trigger events for underperforming third party processes were identified in the user's browsing session. If no trigger events for underperforming third party processes were identified, the method 400 advances to a block 414. If trigger events were identified, the method 400 advances to a block

At block 414 the one or more processors determine whether the user has ended the browsing session. The determination may be based on, for example, whether the user closed the browser, or navigated to a different website within the same browser window, or whether the browsing session terminated due to user inactivity for a certain period of time (e.g., 30 minutes). If the determination is made that the user has ended the browsing session, the method 400 ends. If the determination is made that the user has not ended the browsing session, the method 400 returns back to the block 412 to continue checking for trigger events.

At block 416, in some embodiments, the one or more processors may notify the third party provider(s) of the identified trigger event(s) for the underperforming processes in response to determining the occurrence of a trigger event at block 412. The notification may be an alert or a status update to an external computing device (e.g., the third party server(s) 118, or a device associated with the third party server(s) 118). The notification may be sent to each of the third party server(s) 118 hosting the respective underperforming third party processes for which trigger events were identified. The alert, notification, or the status update to each of the providers of the third party processes may also include a list of the underperforming third party processes associated with the identified trigger events. In some embodiments, the notification may also include the conditions or environmental parameters associated with low performance. In some embodiments, the notification may also include estimates of negative user impact (such as estimated load delay, restricted access, or delayed or restricted invocation) of the underperforming third party processes. The notification may be, for example, a graphical user notification, a push notification, a notification via a network socket, an email message, a text message, or a phone call. The notification may contain text and/or visual or graphic information. The alerts, notifications, or status updates may be stored in cache, datastore, memory, etc. (e.g., memory 106 or 122) for subsequent recall.

In embodiments, there may be different notification protocols for different trigger events, and/or different third party processes associated with the trigger events, and/or different performance metrics of the third party processes associated with the trigger events. There may be different alerting protocols for different third party providers. For example, each third party provider may have a preferred notification method and notification content. In embodiments, the timing, content, and method of the notification may depend on the performance metrics of the underperforming third party processes. In embodiments where triggers are associated with weights corresponding to the probability of each trigger event leading to access of a respective third party process, the protocols of notifying the respective third party provider(s) may vary depending on the trigger event weight.

At block 418 the one or more processors causes a corrective action to be implemented to avoid or reduce the performance impact from the identified one or more third party processes. For example, the corrective action may be similar to the corrective actions of block 214, such as proactively loading or partially loading a third party process, loading a different version or a different third party process, displaying a third party process only when actually accessed, or disabling a third party process, which may prevent or decrease web page content access delays. In some embodiments, the corrective action may include providing an alert or notification to the web host associated with the client website (e.g., the website host server 102). Such alert or notification may include an automated message or a call to an API of the website host server 102 to cause the website host server 102 to perform such corrective actions with respect to the user device (e.g., the end-user device 132). The method 400 may then continue back to the block 412 to continue checking for further trigger events. The previously implemented corrective action may be flagged or otherwise persisted in memory associated with the browsing session to avoid duplicative identification of the previously addressed trigger event conditions. Thus, the method may continue checking for new trigger events until the browsing session is determined to be ended at block 414, at which point the method 400 terminates.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

Although individual operations of one or more methods are illustrated and described as separate operations, one or more of the individual operations may be performed concurrently, and nothing requires that the operations be performed in the order illustrated. Structures and components presented as separate components in example configurations may be implemented as a combined structure or component. Similarly, structures and components presented as a single component may be implemented as separate components. These and other variations, modifications, additions, and improvements fall within the scope of the subject matter herein.

To the extent that any term recited in the claims at the end of this disclosure is referred to in this disclosure in a manner consistent with a single meaning, that is done for the sake of clarity only so as not to confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

What is claimed is:

1. A method for profiling web page performance, comprising:
selecting, by one or more processors, a target web page including a plurality of embedded processes;
selecting, by one or more processors, a testing environment for evaluation of performance of the target web page;
loading, by one or more processors, the target web page in the testing environment;
acquiring, by one or more processors, data related to performance metrics of third party processes of the target web page;
determining, by one or more processors, a group of underperforming third party processes, wherein the group of underperforming third party processes are third party processes with performance metrics below one or more respective thresholds; and
implementing, by one or more processors, a corrective action associated with the group of underperforming third party processes.

2. The method of claim 1, wherein the testing environment includes at least one of a device type, the device's operating system type, the device's web browser type, a geographical location, and a connection speed.

3. The method of claim 1, wherein the performance metrics of the third party processes comprise load times, processing time, accesses, and invocations of at least some of the embedded processes.

4. The method of claim 1, further comprising presenting to a user the group of underperforming third party processes, including data on negative user impact of the group of underperforming third party processes.

5. The method of claim 1, wherein presenting to the user the identified group of underperforming third party processes comprises presenting respective metrics of the underperforming third party processes.

6. The method of claim 1, wherein the corrective action includes preloading the underperforming third party processes.

7. The method of claim 1, wherein the corrective action includes loading the target web page without the underperforming third party processes.

8. The method of claim 1, wherein the corrective action includes sending one or more notifications to third parties associated with the group of underperforming third party processes.

9. The method of claim 1, wherein the corrective action includes updating a service level agreement between a host of the target web page and at least one of providers of the underperforming third party processes.

10. A computing system for profiling web page performance, comprising:
one or more processors;
one or more non-transitory memories communicatively coupled to one or more processors and storing computer-executable instructions that, when executed by the one or more processors, cause the computing system to:
select a target web page including a plurality of embedded processes;
select a testing environment for evaluation of performance of the target web page;
load the target web page in the testing environment;
acquire data related to performance metrics of third party processes of the target web page;
determine a group of underperforming third party processes, wherein the group of underperforming third party processes are third party processes with performance metrics below one or more respective thresholds; and
implement a corrective action associated with the group of underperforming third party processes.

11. The system of claim 10, wherein the testing environment includes at least one of a device type, the device's operating system type, the device's web browser type, a geographical location, and a connection speed.

12. The system of claim 10, wherein the third party processes performance metrics comprise load times, processing times, accesses, and invocations of at least some of the embedded processes.

13. The system of claim 10, wherein the computer-executable instructions further cause the computing system to present to a user the group of underperforming third party processes, including data on negative user impact of the group of underperforming third party processes and respective metrics of the underperforming third party processes.

14. The system of claim 10, wherein the corrective action includes preloading the underperforming third party processes.

15. The system of claim 10, wherein the corrective action includes loading the target web page without the underperforming third party processes.

16. A tangible, non-transitory computer readable storage medium storing computer-executable instructions for profiling web page performance, the instructions, when executed on one or more processors, cause the one or more processors to:
select a target web page including a plurality of embedded processes;
select a testing environment for evaluation of performance of the target web page;
load the target web page in the testing environment;
acquire data related to performance metrics of third party processes of the target web page;
determine a group of underperforming third party processes, wherein the group of underperforming third party processes are third party processes with performance metrics below one or more respective thresholds; and
implement a corrective action associated with the group of underperforming third party processes.

17. The tangible, non-transitory computer readable storage medium of claim 16, wherein the testing environment includes at least one of a device type, the device's operating system type, the device's web browser type, a geographical location, and a connection speed.

18. The tangible, non-transitory computer readable storage medium of claim 16, wherein the third party processes performance metrics comprise load times, processing times, accesses, and invocations of at least some of the embedded processes.

19. The tangible, non-transitory computer readable storage medium of claim 16, wherein the computer-executable instructions further cause the one or more processors to present to a user the group of underperforming third party processes, including data on negative user impact of the group of underperforming third party processes and respective metrics of the underperforming third party processes.

20. The tangible, non-transitory computer readable storage medium of claim 16, wherein the corrective action includes loading the target web page without the underperforming third party processes.
